(19) United States
(12) Patent Application Publication
(10) Pub. No.: US 2007/0183010 A1
(43) Pub. Date: Aug. 9, 2007

(54) Method for service information projection

(76) Inventor: Frank John Williams, Los Alamitos, CA (US)

Correspondence Address: Frank John Williams, 2711 Saint Albans Dr, Los Alamitos, CA, 90720, US

(21) Appl. No.: 11/703,467

(22) Filed: Feb. 5, 2007

Related U.S. Application Data
(60) Provisional application No. 60/764,931, filed on Feb. 3, 2006.
(60) Provisional application No. 60/780,473, filed on Mar. 8, 2006.

(51) Int. Cl. G02B 5/32

(52) U.S. Cl. 359/15

(57) ABSTRACT

A method for providing information for demonstrating at least one image of a service procedure of an apparatus, wherein said image is projected on a surface neighboring and/or on an apparatus.

### RELATED APPLICATIONS

This application claims the benefit of: provisional patent application Ser. No. 60/764,931 filed 2006 Feb. 3, and provisional patent application 60/780,473 filed 2006 Mar. 8, by the present inventor

### BACKGROUND

1. Field of the Present Disclosure

This disclosure relates to a method for providing service information and support to a viewer. More specifically, a method implementing projection of an image in order to demonstrate a service procedure of an apparatus.

2. Description of Related Art

Because of the evolution of technology, the modern machine incorporates a series of capabilities and functionality. Service procedures to keep these machines running and functional have also evolved into complex and elaborate procedures. Consequentially, the amount of information, experience, support and/or parts required to ensure the successful repair and service of these machines, involves many factors and circumstances. In addition, large quantities of money, time, resources and human effort are spent every day training, educating, supporting, warranting, assisting and servicing these apparatuses, their service personnel and end-users.

The recent digital revolution, allows people to quickly access information. Suggestively, information demonstrating the complex service procedures of the modern and complex apparatus is obtainable by many means. However, even when this important and valuable information is provided to the viewer, means for displaying it and making accessible are absolutely necessary. Without a display, demonstrative and sampling type the information is inaccessible. Furthermore, the display providing the service information is many times located at a remote location from the apparatus and/or in environment that is unlikely for the display means to co-exist. For example, a movie demonstrating the service procedure of replacing the drive belts of a large copier machine must be seen by the technician in a computer that is indeed many feet away. In addition, geometric memory of the viewer can quickly increase the time required to learn the procedure and/or accumulate the possibilities to confuse or mistake a process of the procedure and/or element part of the apparatus.

any of these graphic displaying means can easily be used to disseminate, demonstrate or.

Patents such as: U.S. Pat. No. 4,009,524 Valentine, discloses a method for teaching and interacting with the information of the apparatus, such as an automobile. However, the method teaches away of implementations for remote support purposes. U.S. Pat. No. 6,652,286 Larsen, disclose a method for using a projector for teaching a group of students and conceals the solutions, thus also teaching away. U.S. Pat. No. 4,092,785 Forsman, disclose methods for displaying means of an apparatus, yet fails to mention implementing any such system(s) for providing remote technical assistance. In addition, U.S. Pat. No. 6,317,570 Uchida et al, U.S. Pat. No. 5,802,429 Yamashita, U.S. patent application publication US 2004/0186598 A1 Tanaka, and U.S. Pat. No. 5,715,496 Sawada et al, disclose several methods of obtaining information directly from the apparatuses for intents of remote diagnosis, and possible equipment management. Unfortunately they all fail of providing service information to the client, for performing service procedures.

In view of the foregoing and shortcomings, the disclosed inventive method teaches away from current and prior methods, while solving felt needs and provides unappreciated advantages distinguishing it over the prior art by also providing heretofore additional unknown advantages as described in the following summary.

### SUMMARY

It is therefore the object of the present invention to teach a method for providing graphical service information for an apparatus without the limitations encountered by a display means. In such fashion, clients can quickly, objectively, and affordably access important servicing information in locations and/or under situations wherein means for a display means to exist is not available. Furthermore, the method and disclosure teaches certain benefits in construction and use which give rise to the objectives described below.

A primary objective inherent in the above described method is to provide advantages not taught by the prior art;

Another objective is to provide a superior way for demonstrating a service procedure of an apparatus;

Another objective is to provide for the demonstration of elaborate and complex procedures;

Another objective is to provide information of complex service procedures;

Another objective is to avoid the extrapolation of service procedures' information;

Another objective is to provide service procedure information on remote and inaccessible locations;

Another objective is to reduce dependency on the viewer's geometric memory for performing service procedures;

Another objective is to facilitate the performance of complex service procedures by displaying the service information;

Another objective is to save viewer time by reducing the amount of times a media demonstrating a service procedure has to be repeated.

Another objective is to standardize the quantity and quantity of technical information;

Another objective is to alleviate warranty related repairs and/or expenses;

Another objective is to provide manufacturers' with an additional medium to distribute and provide service information;

A further objective is to allow manufacturers and/or technical entities to quickly introduce or add new service procedure information handling unfortunate service events;

A further objective is to increase the troubleshooting success rate of technicians and end-users alike;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present inventive method. In such drawings:

FIG. 1 illustrates a general non-limiting flow chart of the inventive method;

FIG. 2 illustrates a non-limiting diagram of a service procedure being projected on an apparatus;

FIG. 3 illustrates a non-limiting flow chart of the inventive method comprising the implementation of a smart system;

Figure illustrates another general non-limiting example on the inventive method

### DETAILED DESCRIPTION OF THE PREFERRED EMBODIMENT

The above described drawing figures illustrate the described method for providing service information in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

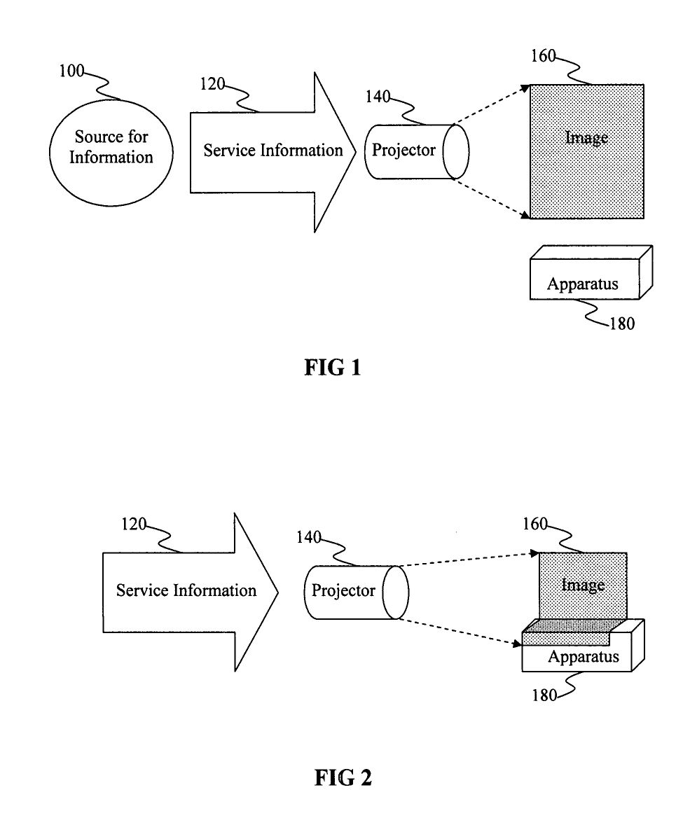

FIG. 1 illustrates a general non-limiting flow chart of the inventive method. In FIG. 1, the Source for Information 100 (FIG. 1) provides a Service Information 120 (FIG. 1), such as a movie, slide-show or a still image demonstrating a service procedure of an apparatus. The service Information 120 (FIG. 1) is utilized by the projecting means 140 (FIG. 1) to form the image 160 (FIG. 1) demonstrating a service procedure of an apparatus on the neighborhood of the apparatus 180 (FIG. 1).

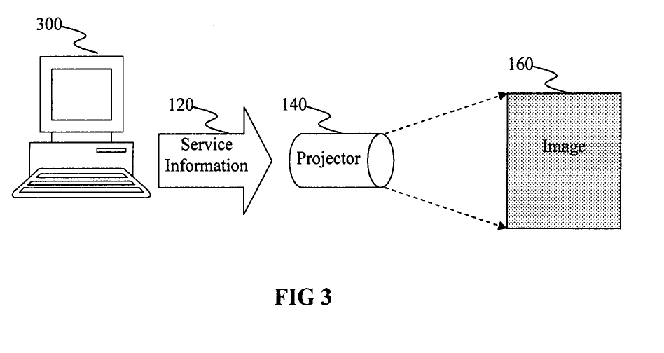

FIG. 2 illustrates a non-limiting diagram of a service procedure being projected on an apparatus. The Service information 120 (FIG. 2), such as a movie demonstrating the service procedure of an apparatus is implemented by the projecting means 140 (FIG. 2), to form the image 160 (FIG. 2) on the surface of the apparatus 180 (FIG. 2).

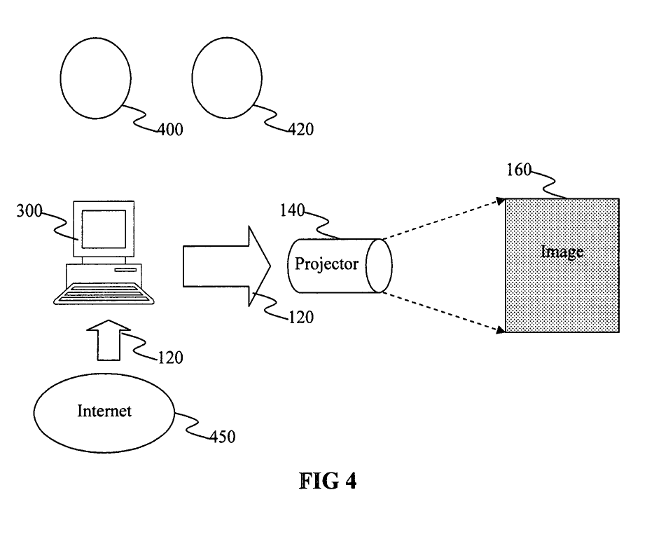

FIG. 3 illustrates an exemplary smart system 300 (FIG. 3), such as a computer, portable computer, hand held device, cell phone, etc. for selecting and/or manipulating the service information 120 (FIG. 3), which is sent to the projecting means 140 (FIG. 2) to form the image 160 (FIG. 3) demonstrating a service procedure of an apparatus.

FIG. 4 illustrates another general non-limiting example of the inventive method. A viewer 400 (FIG. 4), such as a technician or end-user, talks or communicates with a technical support entity 420 (FIG. 4), such as a technical support representative. Then, the viewer' smart system 300 (FIG. 4) is used to received the information 100 (FIG. 4) demonstrating a service procedure from a second information source 450 (FIG. 4) such as an Internet or Intranet. The received information 100 (FIG. 4) is sent to the projecting means 140 (FIG. 4), which then forms the image 160 (FIG. 4) demonstrating a service procedure of an apparatus.

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the present disclosed inventive method, it can be appreciated a novel method for providing and demonstrating a service procedure of an apparatus comprising a projected image to teach and exemplify the said service procedure.

1. A method for providing technical support, comprising the steps of:
a) Communicating with an entity seeking service information
b) Providing to said seeking entity an information identifying a service procedure of an apparatus
C) Said seeking entity obtaining a service information demonstrating a service procedure
D) Projecting said service information demonstrating a service procedure
